(19) United States
(12) Patent Application Publication
(10) Pub. No.: US 2003/0178585 A1
(43) Pub. Date: Sep. 25, 2003

(54) Scanning method and apparatus for distinguishing size of image object automatically

(76) Inventor: Jen-Shou Tseng, MiaoLi (TW)

Correspondence Address: Raymond Sun, 12420 Woodhall Way, Tustin, CA, 92782, US

(21) Appl. No.: 10/103,243

(22) Filed: Mar. 21, 2002

(51) Int. Cl. G01N 21/86

(52) U.S. Cl. 250/559.24

(57) ABSTRACT

The invention discloses a scanning method and apparatus for distinguishing size of image object automatically, which is applied in a procedure for pre-scanning an image object executed by an optical scanner. Wherein, after the pre-scanning procedure, the size of the image object may be obtained immediately, and the procedure of image picking-up may be automated by the method provided by the invention. Further, the invention provides a scaled pattern that is designed in the optical apparatus, thereby a quantified relationship of scale between the scaled pattern and the image object may be obtained. Furthermore, the quantified relationship of scale may be applied for calculating out the size of the image object by using the designation of several patterns relatively. Wherein, the quantified relationship and the relative size of image object may be calculated by predetermined design, and the variation of brilliance may also be calculated during the pre-scanning procedure.

### 1. FIELD OF THE INVENTION

The invention relates to a scanning method and apparatus for distinguishing size of image object automatically, especially to a pre-scanning procedure of an image object executed by an optical scanner, and the size of the image object can be obtained immediately after the pre-scanning procedure of the image object, and at the same time, the pre-scanning procedure is also ended.

### 2. BACKGROUND OF THE INVENTION

Following the daily progress of high technology, especially for the technology of micro-electron being developed almost every day, the computer has already penetrated into every family and enterprise and has become an indispensable electronic product in our daily modern lives. With the prevalence of the multi-media of computer, more peripheral products are needed for serving as input and output devices. According to the progressive technology of the photoelectric semiconductor, the product technologies of relative peripheral devices of computer, such as optical scanner, are sophisticated and prevalent day by day and their products have already become the necessary peripheral devices for computer. Wherein, the optical scanner further becomes an important peripheral device for input and output for computer. An optical scanner mainly applies a light source module to provide light source for scanning document, and further applies a device of optical length to receive the reflective image of the scanned document, and then picks up the document image by a charge-coupled device and, through the transformation of the photoelectric signals generated by the CCD, the digital signals are then transferred to a computer for processing image treatment.

Please refer to FIG. 1, which is a three-dimensional illustration of a flatbed optical scanner according to the prior arts capable of scanning reflective image object. As shown in FIG. 1, the flatbed optical scanner 1 includes an upper cover 10 and a hollow outer case 11. A document window glass 12 is arranged on the upper side surface of the outer case 11, where a reflective document 16 to be scanned is placed. Driven by a transmission apparatus 13, an optical chassis 14 is moved along a guiding rod 15 in the hollow outer case 11 for making a linear motion to execute a scanning job of image for the document 16 placed on the document window glass 12.

Please refer to FIG. 2, which is a three-dimensional illustration for the flatbed optical scanner according to the prior arts capable of scanning a reflective image object. As shown in FIG. 2, the flatbed optical scanner 2 includes an upper cover 20 and an outer case 21. A document window glass 22 is arranged on the upper side surface of the outer case 21. When the scanner 2 is to proceed a scanning job of reflective document, a reflective document 26 is placed on the document window glass 22 and, brought along by a driving apparatus 23, an optical chassis 24 is moved along a guiding rod to make a linear motion of image scanning in the hollow outer case 21 for executing an image scanning job to the reflective document 26 placed on the document window glass 22.

Wherein, when the scanner 2 is to proceed a scanning job of transparent document, the document window glass 22 may also be placed with a transparency-placing frame 27, in which plural transparent documents 271 may be arranged. Further, an upper light source module 28 arranged at the upper cover 20 provides a light source irradiating a light downward the transparent document 271, and a transparent glass 29 is also designed for making the light beam of the upper light source module 28 penetrate through and then be incident on the transparent document 271. Brought along by the driving apparatus 23, the optical chassis 24 is moved along the guiding rod 15 to make a linear motion inside the hollow outer case 11 for executing an scanning job to the transparent document 271 placed on the document window glass 22.

Please refer to FIG. 3A, which is a cross-sectional illustration for the flatbed optical scanner according to the prior arts having an upper light source apparatus of transmission type. Wherein, a transparency-placing frame 27 is placed on the outer case 21, and the upper light source module 28 is covered on the transparency-placing frame 27. A light-backing source apparatus 281 arranged in the upper light source module 28 has a light source 282 and is arranged with an upper sliding rod 282. The light-backing source apparatus 281 is moved back and forth along the extensive direction of the upper sliding rod 282 inside the upper light source module 28 for cooperating with the optical chassis 24 to execute a scanning job to the transparent document 271.

Please refer to FIG. 3B, which is an illustration for the cross-sectional structure of the flatbed optical scanner according to the priors having an upper light source apparatus of fixation type. Wherein, a fixed light-backing plate 284 is arranged in the upper light source module 28, and there is a light source 285 arranged respectively in the two sides of the fixed light-backing plate 284 for providing a light incident toward the light-backing plate 284 and reflected back toward the transparent document 271 for cooperating with the optical chassis 24 to execute an image scanning job to the transparent document 271.

For any kind of optical scanner belonged to the reflective image scanning type or the transparent image scanning type as described thereinbefore, a pre-scanning motion has to be made before scanning an image object to be scanned to distinguish its size and the range to be scanned and, thereby these data are provided to the formal scanning process executed on this image object with accurate scanning range. In general, independent on the size of the image, the pre-scanning process will be executed over the entire area of the document window glass and, before the following formal scanning process is started, the scanning range has to be arranged in manual, otherwise the entire area of the document window glass will be scanned during formal scanning process, and this kind of operation not only wastes the time of user but also wastes the memory resource inside the computer system.

Please refer to FIG. 4A, which is a simple illustration for a scanner according to the prior arts where an image document being placed. As shown in FIG. 4A, an image document 260 is placed on a transparent placing glass 12 of an outer case 11 of a scanner, wherein the face to be scanned is faced down. During the pre-scanning process for the image, the scanning direction in Y-axis direction is from Y1 to Y2, and the scanning direction in X-axis direction is from X1 to X2 (i.e., process an X-axis scan under one single point of Y-axis being fixed and, after one X-axis scan being finished, continue to process another X-axis scan with another single point of Y-axis being fixed), that is, the entire area W1*W2 of the transparent placing glass 12 is scanned. Therefore, although the scanning area desired by the user is just the size of the document 260, but the area of the size of the document 260 will not be scanned by the pre-scanning process.

Please refer to FIG. 4B, which is a simple illustration that a document image is being transferred to a displaying apparatus after being pre-scanned by a scanner. As shown in FIG. 4B, after the pre-scanning motion described in FIG. 4A is finished, a document image 261 of the document 260 is displayed on a screen 3 after it being pre-scanned by a scanner, wherein a user has to make a selection motion to the pre-scanned document image 261 in manual. In general, after selecting a desired area of the pre-scanned document image 261 by applying a sliding circle of selection frames 30 and 31, a formal scanning process of the scanner is then started. If the user does not select any area to be scanned, then the scanner will scan the entire area of the scanning window (the range of the transparent placing glass 12) during the formal scanning process, that is, from Y1 to Y2 in the Y-axis direction and from X1 to X2 in the X-axis direction, as shown in FIG. 4B.

Obviously, through above description, the pre-scanning process according to the prior arts actually wastes the user too much valuable time. The process not only is tedious and troublesome but also reduces the life cycle of a scanner invisibly. In present technical times, it is obvious that there are still lots of room to be improved and these improvements are especially important for the factories or enterprises that emphasize automation.

### SUMMARY OF THE INVENTION

The invention is an innovation to solve the all shortcomings of prior arts thereinbefore, and addresses an applicable method and relative apparatus to realize the invention. The main object of the invention is to design a scanning method and apparatus for automatically distinguishing size of an image object and apply it in a pre-scanning procedure executed by an optical scanner and, after the image object is scanned, the size of the image object can be obtained and, in the mean time, the pre-scanned procedure is ended to start the formal scanning procedure for automating the procedure of image picking-up.

Another object of the invention is to design a scaled pattern arranged in an optical scanner and, thereby a quantified relationship of scale may be obtained between the scaled pattern and the image object during the pre-scanning procedure; that is, through the designation of several patterns and lines, the quantified relationship of scale may calculate out the size of the image object, wherein the quantified relationship and the relative size of the image object can be treated and calculated by a design of software.

A scanning apparatus for automatically distinguishing size of image object according to an embodiment disclosed by the invention, wherein a scaled pattern is designed in an optical scanning apparatus, and a quantified relationship of relative position may be generated by the scaled pattern and the image to be scanned and, again through a scanning means, the image to be scanned is scanned by the optical scanning apparatus and through a predetermined value of the scaled pattern, a relationship between the brilliance of the image object to be scanned and the predetermined value is calculated during the scanning procedure and, after the size of the image object is obtained, the scanning procedure is over.

A flowchart of executing steps according to the scanning method of the invention includes following steps:

a. Prepare the scanner;

b. Prepare the document to be scanned;

c. Start the scanner;

d. Start to pre-scan;

e. For a fixed value of width in the direction of Y-axis, the data of the scanned image is calculated until the value of brilliance in the direction of X-axis without any change;

f. For a fixed size and position in the direction of X-axis, the data of the scanned image is output;

g. The scan of document has reached the terminal;

h. Obtain the data of image until a continuous value of brilliance having no further change in the direction of Y-axis;

i. Stop the pre-scanning process, and stop the rotation of motor;

j. Reverse the motor, and bring the optical chassis back to initial position.

A scaled pattern is designed in another embodiment according to the invention, wherein the flowchart of executing steps includes following steps:

a. Prepare the scanner;

b. Prepare the document to be scanned;

c. Start the scanner;

d. Start to pre-scan;

e. For a fixed position and direction of the X-axis, the brilliance performance of the image data is calculated and compared with that of a scaled pattern;

f. Judge the size and the position of the document below the direction of X-axis;

g. Determine the size and the position of the document below the direction of X-axis;

h. Output the image data, and continue to pre-scan;

i. With no change in the direction of Y-axis, the full width of the document is obtained (when the value of continuous brilliance does not change any more);

j. Determine the size of image below the direction of X-axis;

k. Stop the pre-scanning process, and stop the rotation of motor; 6

l. Reverse the motor, and bring the optical chassis back to its initial position.

### BRIEF DESCRIPTION OF THE DRAWINGS

FIG. 1 is an illustration for a three-dimensional structure of a flatbed optical scanner according to the prior arts capable of scanning a reflective image object.

FIG. 2 is an illustration for a three-dimensional structure for a flatbed optical scanner according to the prior arts capable of scanning a transparent image object.

FIG. 3A is an illustration for a cross-sectional structure for a flatbed optical scanner according to the prior arts having an upper light source apparatus of transmission type.

FIG. 3B is an illustration for a cross-sectional structure for a flatbed optical scanner according to the prior arts having an upper light source apparatus of fixation type.

FIG. 4A is a simple illustration for a scanner according to the prior arts where an image document is placed thereof.

FIG. 4B is a simple illustration that a document image is outputted to a displaying apparatus after being scanned by a scanner.

FIG. 5A is the first preferable embodiment of a scaled pattern according to the invention.

FIG. 5B is the first preferable embodiment according to the invention wherein a scaled pattern is fixed onto the transparency-placing glass by a pasting method.

FIG. 5C is the second preferable embodiment according to the invention wherein a scaled pattern is fixed onto the transparency-placing glass by a pasting method.

FIG. 5D is the first preferable embodiment according to the invention wherein a scaled pattern is designed on the upper cover of a scanner capable of scanning a reflective document.

FIG. 6A is the second preferable embodiment of a scaled pattern according to the invention.

FIG. 6B is the second preferable embodiment according to the invention wherein a scaled pattern is designed on the upper cover of a scanner capable of scanning a reflective document.

FIG. 6C is the first preferable embodiment according to the invention wherein a scaled pattern is designed on the upper cover of a scanner capable of scanning a transparent document.

FIG. 6D is the second preferable embodiment according to the invention wherein a scaled pattern is designed on the upper cover of a scanner capable of scanning a transparent document.

FIG. 7 is the first embodiment for the flowchart of execution steps according to the invention.

FIG. 8 is the second embodiment for the flowchart of execution steps according to the invention.

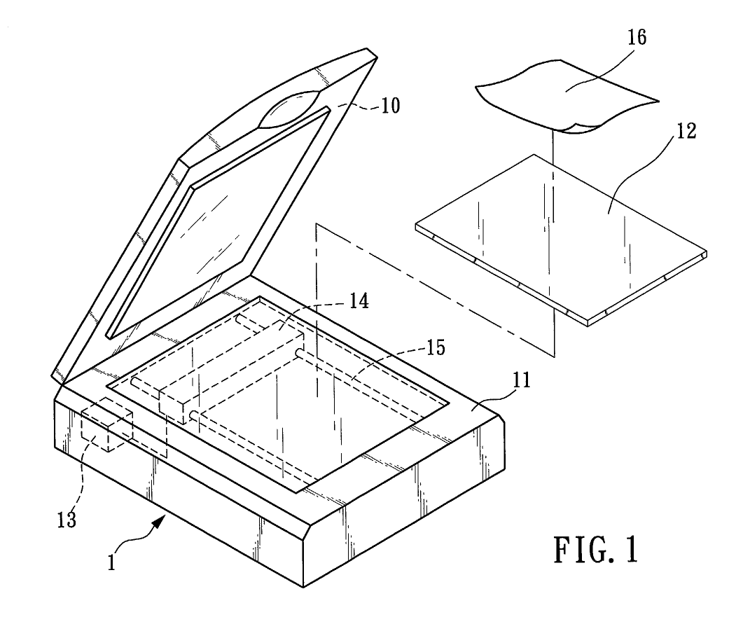

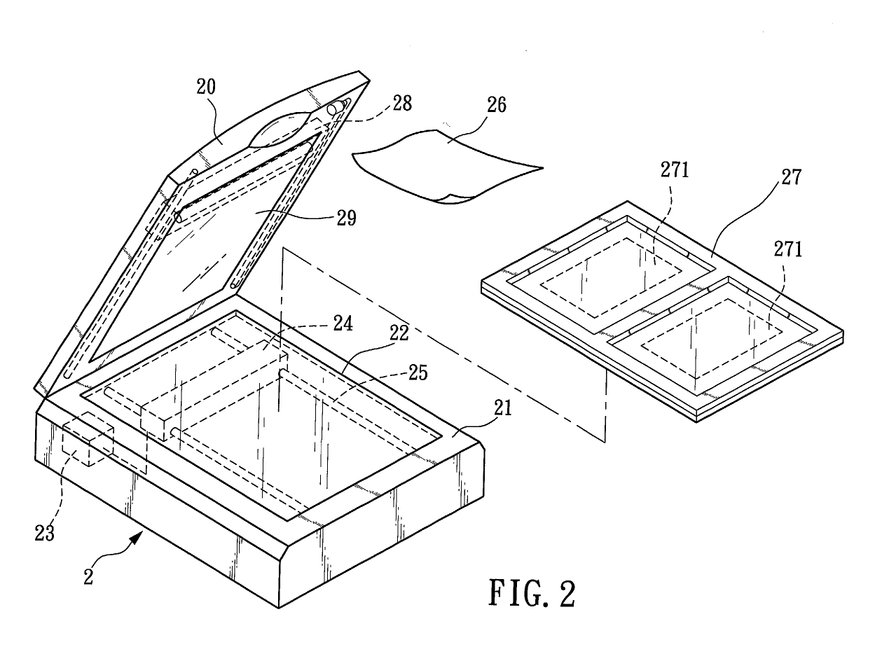

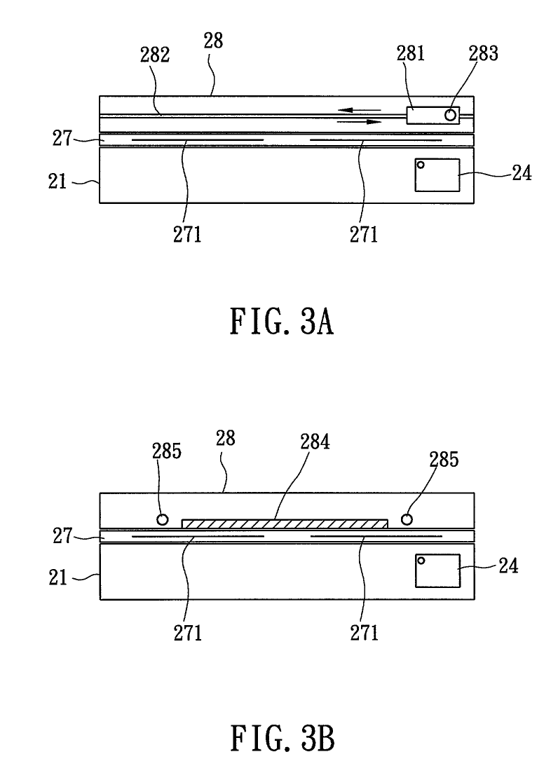

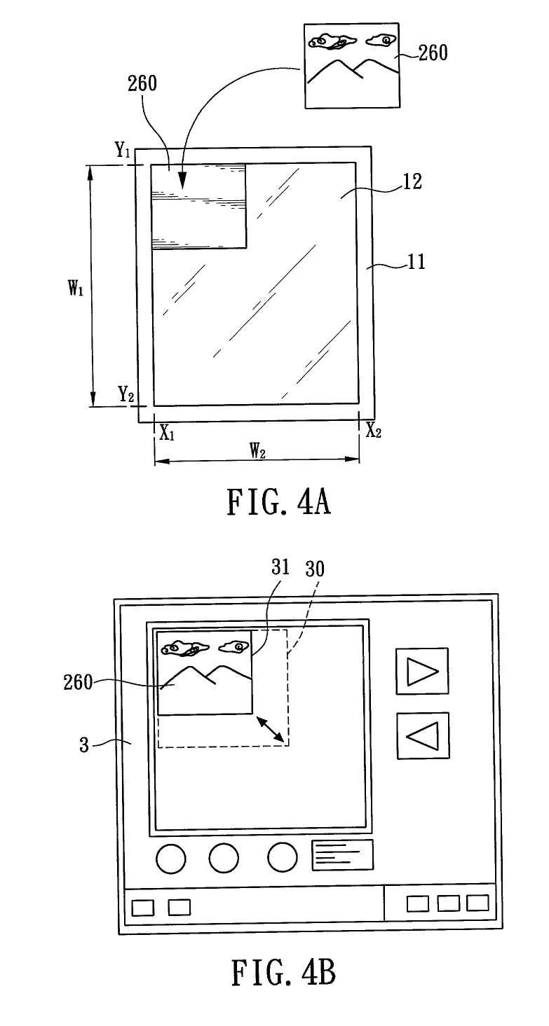

### DETAILED DESCRIPTION OF THE INVENTION

The invention is to disclose a scanning method and apparatus for automatically distinguishing size of an image object and apply it in a pre-scanning procedure executed by an optical scanner and, after the image object is scanned, the size of the image object can be obtained and, in the mean time, the pre-scanned procedure is ended for automating the procedure of image picking-up by the method provided by the invention.

A scaled pattern provided by the invention is designed in an optical scanner and, after the image object is placed on the position to scan, a quantified relationship of scale may be obtained between the scaled pattern and the image object during pre-scanning procedure; that is, through the designation of several patterns, the quantified relationship of scale may calculate out the size of the image object, wherein the quantified relationship and the relative size of the image object can be treated and calculated by a design of software; that is, the pattern is made to have a meaning on scale treatable by an electronic apparatus through a predetermined design.

During the procedure of pre-scanning, the variation of brilliance obtained through scanning the image object is also calculated and, when the brilliance value does not to change any more, it is known that the scanning range of the image object is ended. At this time, the width of the image object may be obtained, and an actual size of the image object may also be obtained by contrasting with the predetermined meaning of design represented by the scaled pattern, and the entire pre-scanning procedure is over. Next, the optical chassis is back to initial position for executing a formal scanning process on the image object.

Therefore, for a scanning apparatus for automatically distinguishing size of image object according to an embodiment disclosed by the invention, wherein a scaled pattern is designed in an optical scanning apparatus, and a quantified relationship of relative position may be generated by the scaled pattern and the image to be scanned and, again through a scanning means, the image to be scanned is scanned by the optical scanning apparatus and, through a predetermined value of the scaled pattern, a relationship between the brilliance of the image object to be scanned and the predetermined value is calculated during the pre-scanning procedure and, after the size of the image object is obtained, the pre-scanning procedure is over.

According to the invention, it is not necessary to pre-scan the all range of the scanning window for saving the time of pre-scanning process, neither is the user needed to predetermine the size of image, nor is the user needed to select the image range to be scanned in manual in advance. Actually, the real size of the image object is already found during the pre-scanning process according to the invention, and the entire image scanning procedure (including pre-scanning process) is executed by the mode of automatic treatment of computer.

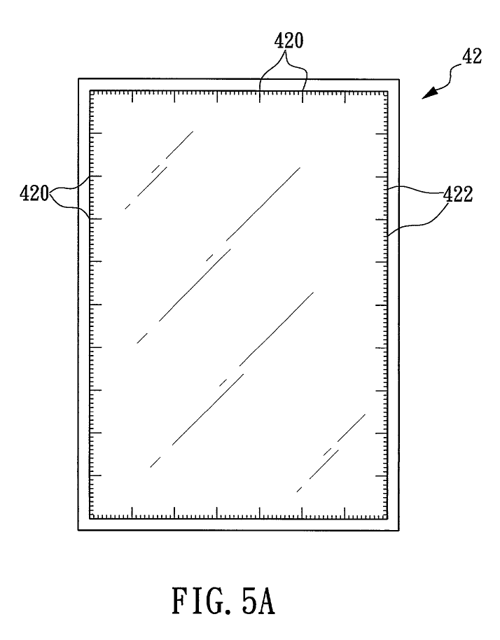

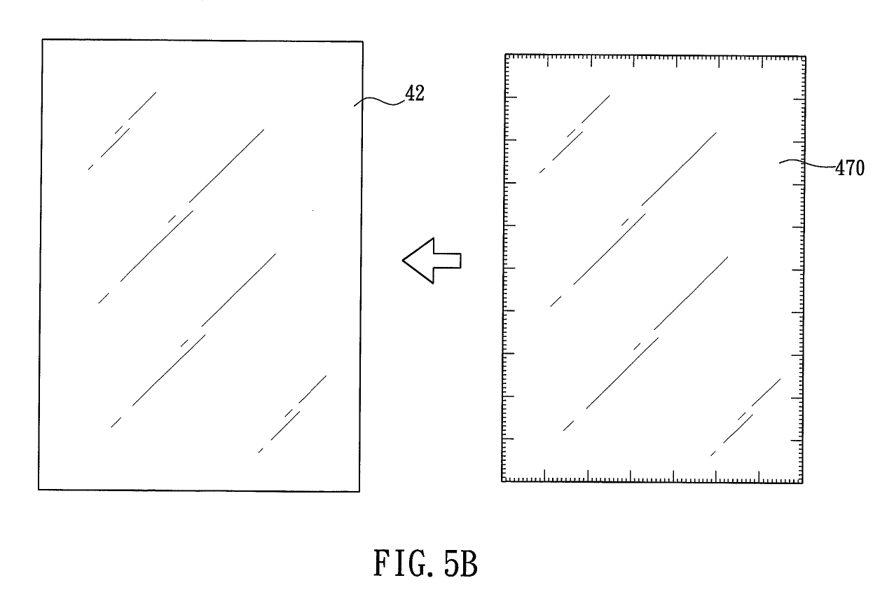

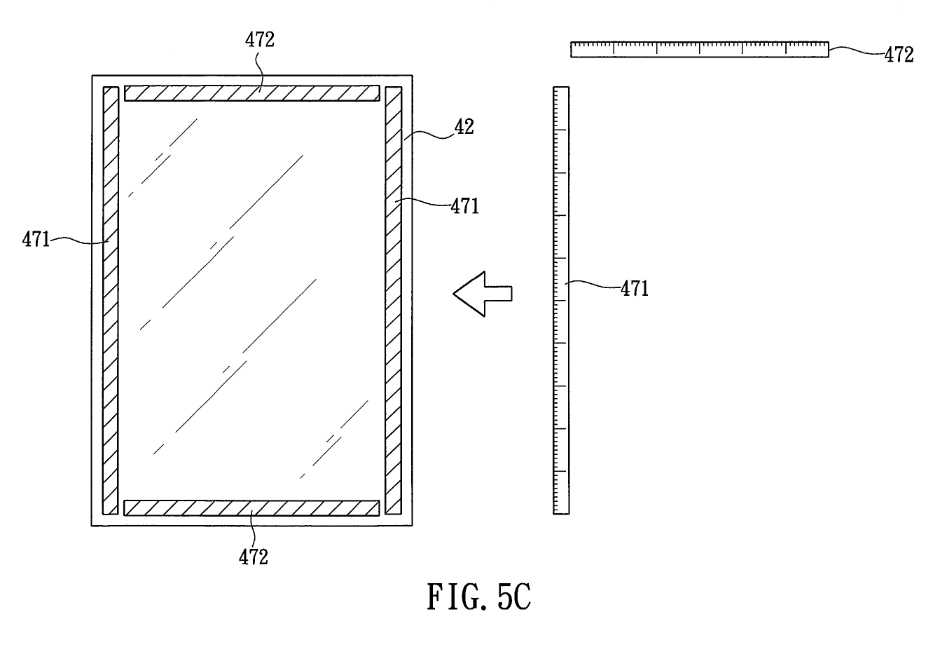

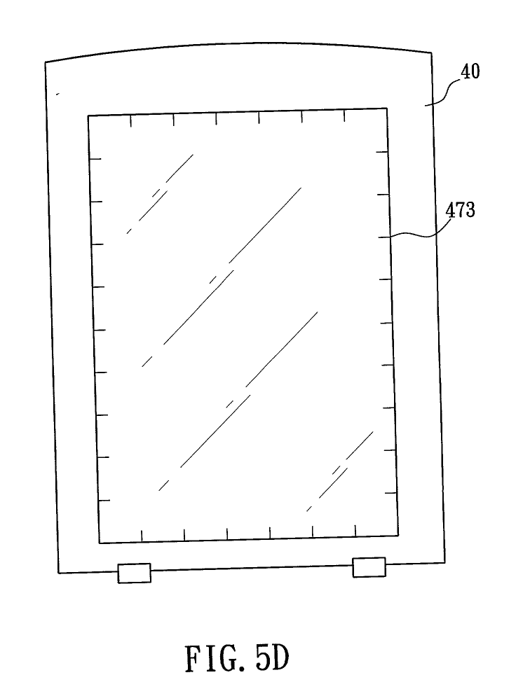

Please refer to FIG. 5A, which is the first preferable embodiment of a scaled pattern according to the invention. As shown in FIG. 5A, several scaled marks 420 are designed on a transparent placing glass 42 that is applied for placing a document to be scanned. Wherein, the number of the several scaled marks 420 may be designed depending on the actual needs, for example, if the transparent placing glass 42 is a rectangular shape, then there are more scaled designations on the longer side than that on the shorter side. Wherein, each scaled designation 420 represents the same distance and, of course, the scaled mark 422 of smaller distance may further be designed on the transparent placing glass 42.

Since the transparent placing glass 42 is a transparent object, so the scaled marks 420 may be designated on the face to be contacted with the document to be scanned, or designated on the face that is close to the optical chassis. Further, the designation of scaled marks on the surface of transparent placing glass 42 may be executed by a printing method, or the scaled marks may be fixed on the transparent placing glass 42 by a pasting method. For example, a mode of transparent tape may be made, and several scaled marks may be designed on the tape too.

Please refer to FIG. 5B, which is the first preferable embodiment according to the invention wherein a scaled mark is fixed on the transparent placing glass by an adhesion method. As shown in FIG. 5B, a transparent tape 470 designated with several scaled marks may be pasted directly on one face of the transparent placing glass 42.

Please refer to FIG. 5C, which is the second embodiment of the invention wherein a scaled pattern is fixed on the transparent placing glass by an adhesion method. As shown in FIG. 5C, there are a longer transparent tape 471 designated with several scaled marks and a shorter transparent tape 472 designated with several scaled marks, wherein the longer transparent tape 471 may be adhered respectively on the two longer sides of the transparent placing glass, while the shorter transparent tape 472 is adhered respectively on the two shorter sides of the transparent placing glass.

Please refer to FIG. 5D, which is the first embodiment according to the invention wherein a scaled pattern is deigned on the upper cover of a scanner capable of scanning a reflective document. As shown in FIG. 5D, a scaled pattern according to the invention may be designed on the inner face of an upper cover 40 of a scanner capable of scanning a reflective document. Wherein, a scaled pattern 473 may be designed on the inner face of the upper cover 40 by a printing method, or adhered by an adhesion tape or transparent tape with scale designed and shown as FIG. 5C. For the preferable embodiment according to the invention, there is no need to design scaled patterns on the transparent placing glass of a scanner.

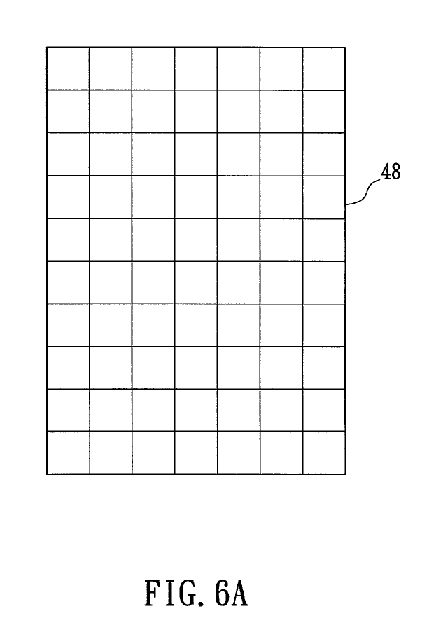

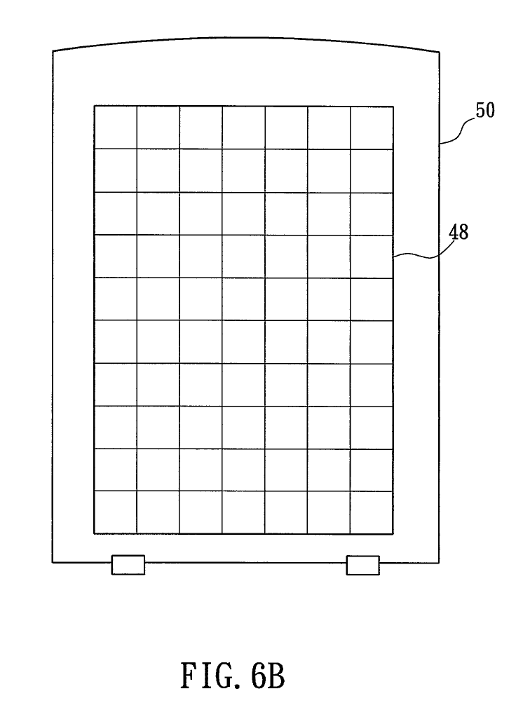

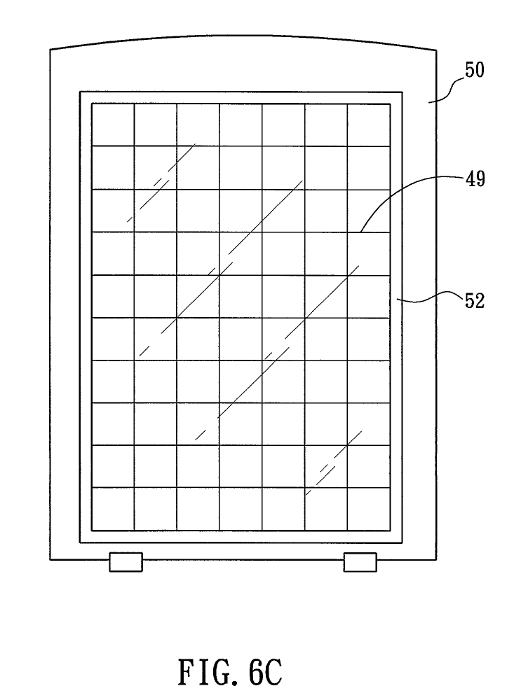

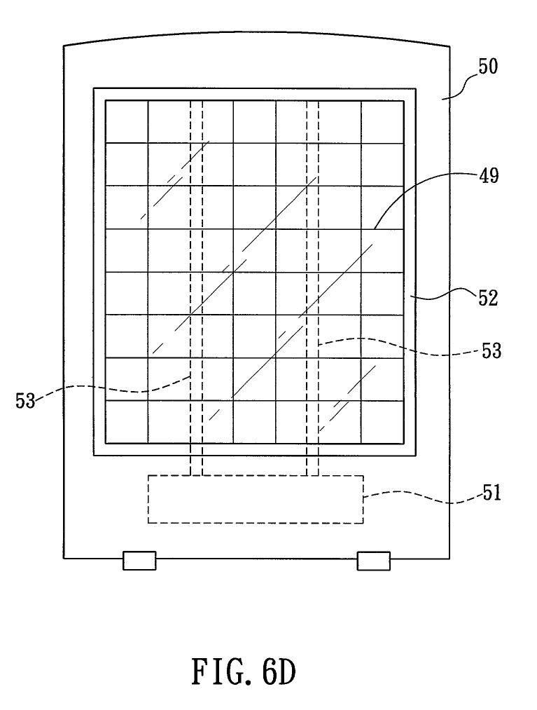

Please refer to FIG. 6A, which is the second preferable embodiment of a scaled pattern according to the invention. As shown in FIG. 6A, the scaled pattern is a drawing of lines of check 48, wherein the width for each line and the needed number of each line is designed depending on the real situation, or designed and calculated according to the maximum range affordable for the image object scanned by the scanner.

Please refer to FIG. 6B, which is the second embodiment according to the invention wherein a scaled pattern is designed on the upper cover of a scanner capable of scanning a reflective document. As shown in FIG. 6B, a scaled pattern shown as a shape of drawing of lines of check 48 according to the invention is designed on the inner face of the upper cover 40 of a scanner capable of scanning reflective document. Wherein, as described in the FIG. 6A, the designing manner of the drawing of lines of check 48 may be a print on the inner face of the upper cover 40, or a tape adhered thereof, or a modular of checked lines for interchanging usage. In this preferable embodiment, there is no need for designing a scaled pattern on the transparent placing glass.

Please refer to FIG. 6C, which is the first preferable embodiment according to the invention wherein a scaled pattern may be designed on the upper cover of a scanner capable of scanning a transparent document. As shown in FIG. 6C, since the upper cover 50 is belonged to an optical scanner capable of scanning transparent document, so there is a transparent glass 52 designed in the upper cover and, therefore, the design of this invention may be executed on the transparent glass 52. Please refer to FIG. 5A through FIG. 5C for the application methods, which describe the invention applied in the transparent placing glass, but the pattern of the scaled designation may be changed to the pattern of drawing of lines of check 49.

Please refer to FIG. 6D, which is the second preferable embodiment according to the invention wherein a scaled pattern may be designed on the upper cover of a scanner capable of scanning a transparent document. As shown in FIG. 6D, a drawing of lines of check 49 is designed on the upper inside wall of the upper cover 50 of a scanner capable of scanning a transparent document, wherein a light-backing source apparatus 51 is moved back and forth along a upper sliding rod 53, and the design and application of the scaled pattern are same as the above description.

It does not matter that the scaled patterns according to the previously described embodiments is a scale of quantification or simply a drawing of lines of check. The main object is to design a function of distinguishing designation to make the size of the image object be distinguished and calculated out during the pre-scanning process of a scanner. Therefore, during the actual design, the designer should not be restricted in the formations of scaled pattern, such as the shape of scale, the magnitude of scale, the distance between the scales, the scale belonging to character, number, or mark, the thickness of lines, or the distance between the lines, etc., as long as the arrangement of scale, mark, drawing can fulfill the sprites and objects of the invention, those embodiments all can be applied and executed by the invention.

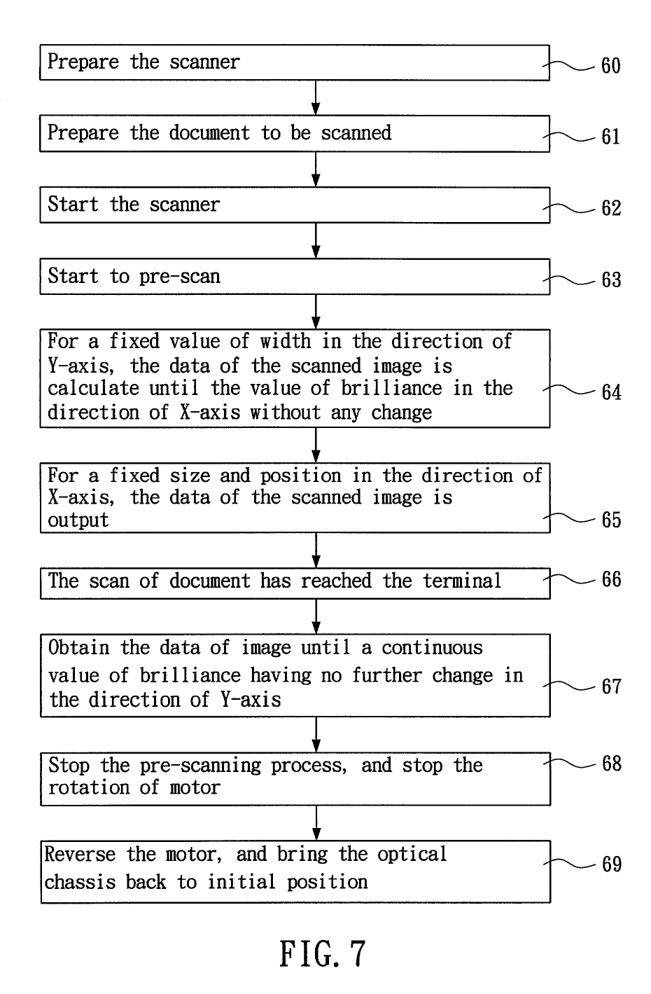

Please refer to FIG. 7, which is a first preferable embodiment of the flowchart of steps according to the invention. As shown in the steps of FIG. 7, a pre-scanning procedure executed on an image object to be scanned may be completed without the implication of a scaled pattern by applying the present method. Especially, in the application in an optical scanner, a design of relative software is cooperated to fulfill the pre-scanning procedure. The pre-scanning method includes following steps:

a. Prepare the scanner 60;

b. Prepare the document to be scanned 61;

c. Start the scanner 62;

d. Start to pre-scan 63;

e. For a fixed value of width in the direction of Y-axis, the data of the scanned image is calculated until the value of brilliance in the direction of X-axis without any change 64;

f. For a fixed size and position in the direction of X-axis, the data of the scanned image is output 65;

g. The scan of document has reached the terminal 66;

h. Obtain the data of image until a continuous value of brilliance having no further change in the direction of Y-axis 67;

i. Stop the pre-scanning process, and stop the rotation of motor;

j. Reverse the motor, and bring the optical chassis back to initial position.

Wherein, the description from step a to step d may be designed in a starting mode, so the starting mode includes that the optical scanning apparatus is actuated and the image object is placed in the optical scanning apparatus and, in the mean time, an optical chassis arranged in the optical scanning apparatus may be checked to make sure that it is placed at an initial position as being preset.

Wherein, as described in step e, during the pre-scanning procedure executed on the image object, a first scanning direction (e.g., the Y-axis direction in plane coordination) is fixed, and the variation of brilliance performance in the second scanning direction (e.g., the X-axis direction in plane coordination) is calculated. Within the data range of scanned image object and during the scanning procedure, the brilliance will be varied due to the different darkness of image object, so, when the scanning process proceeds to the terminal of the scanned document, the brilliance of image will not change anymore because of no image data existing. Wherein, the first scanning direction is designated as the transmission direction of the optical chassis, while the second scanning direction is designated as the extension direction of the optical chassis.

Wherein, the output image data described in step f is the image data obtained in the scanning procedure and is displayed in a displaying apparatus to let the user know the result of scanning. Wherein, the image data obtained in the scanning direction of Y-axis is continuous to output under the condition that the size and the position in the X-direction are fixed.

Wherein, as described in step h, during a scanning procedure executed on the image object, the entire width of the image object has already been obtained in the Y-axis direction and, at this time, it represents the terminal of the document has been reached; that is, the pre-scanning procedure for the image object is going to be over.

Wherein, as described in step i, the pre-scanning procedure is over, and a motor in the transmission apparatus is stopped running.

Wherein, the description in step j is that the optical chassis is moved back to its initial position; that is, the optical chassis is moved to its initial position by the transmission of the transmission apparatus (at this time, the motor should be reversed) and, next, a formal scanning process may be proceeded on the image object. Wherein, according to the data of the moving displacement generated by the transmission apparatus during the scanning procedure, the total width of the image object may also be converted and calculated out.

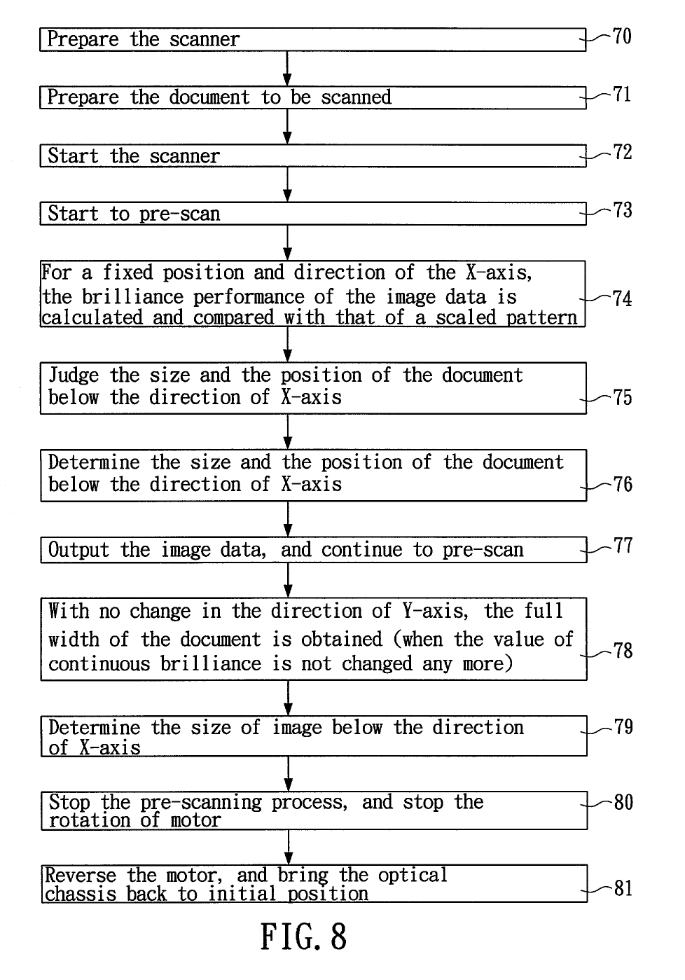

Please refer to FIG. 8, which is the second preferable embodiment of the flowchart of steps according to the invention. As shown in the steps of FIG. 8, a pre-scanning procedure of an image object to be scanned is completed by an arrangement of a scaled pattern according to the present invention, which is particularly suitable to apply in an optical scanner, wherein the optical scanner applies a design of a scaled pattern to make the size and the brilliance performance of the image object be related to the scaled pattern for proceeding a pre-scanning procedure executed on the image object. The present method includes following steps:

a. Prepare the scanner 70;

b. Prepare the document to be scanned 71;

c. Start the scanner 72;

d. Start to pre-scan 73;

e. For a fixed position and direction of the X-axis, the brilliance performance of the image data is calculated and compared with that of a scaled pattern 74;

f. Judge the size and the position of the document below the direction of X-axis 75;

g. Determine the size and the position of the document below the direction of X-axis 76;

h. Output the image data, and continue to pre-scan 77;

i. With no change in the direction of Y-axis, the full width of the document is obtained (when the value of continuous brilliance is not changed any more) 78;

j. Determine the size of image below the direction of X-axis 79;

k. Stop the pre-scanning process, and stop the rotation of motor 80;

l. Reverse the motor, and bring the optical chassis back to the initial position 81.

Wherein, the description from step a to step d may be designed in a starting mode, so the starting mode includes that the optical scanning apparatus is actuated and the image object is placed in the optical scanning apparatus and, in the mean time, an optical chassis arranged in the optical scanning apparatus may be checked to make sure that it is placed at an initial position as being preset.

Wherein, the description of step e means that during the scanning process executed on the image object, the brilliance variation between the image and scaled pattern is calculated and contrasted under the scanning direction of the optical chassis being fixed, and the scanning direction of the optical chassis is defined as the direction of X-axis in the plane coordination. The design of the scaled pattern is to make the size of the image object related to the scaled pattern, and the brilliance performance obtained in the pre-scanning procedure executed on the image object is contrasted with the brilliance performance pre-designed in the scaled pattern.

Wherein, as described in steps f and g, during the scanning procedure, the size and position of the scanned document are judged and determined in the direction of X-axis.

In summarizing the descriptions of steps h, i, j, when the brilliance does not change any more, the whole width of the scanned document is obtained; that is, during the scanning procedure executed on the image object, the entire width of the image object has already been obtained in the direction of Y-axis and, at this time, the pre-scanning procedure executed on the image object is going to be over.

Wherein as described in step k, the motor of a transmission unit of the optical scanning apparatus stops the transmission of the optical chassis for executing the scanning process on the image object; that is, the pre-scanning process is over.

Wherein as described in step l, the optical chassis is moved back to its initial position; that is, the optical chassis is moved to its initial position by the transmission of the transmission apparatus (at this time, the motor should be reversed) and, next, a formal scanning process may be proceeded on the image object.

In summary, according to the invention, instead of pre-scanning the all range of the scanning window as being applied in the prior arts, only the range of the actual size of the object is pre-scanned for saving the time of pre-scanning process, neither is the user needed to predetermine the size of image, nor is the user needed to select the image range to be scanned in manual in advance. Actually, the real size of the image object is already found during the pre-scanning process according to the invention, and the entire image scanning procedure (including pre-scanning process) is executed by the mode of automatic treatment of computer.

Through the all description of the aforementioned preferable embodiments, the method and apparatus for automatically distinguishing the size of the image object disclosed by the invention may actually be applied in a scanning procedure executed by an optical scanner on an image object. After scanning the image object, the size of the image object may be obtained immediately and the pre-scanning procedure may also be finished for shrinking the scanning time for further automating the image picking-up procedure.

In the description mentioned in the previous preferable embodiments, the present applicator considers all the indicators that may be applied to get the real size of the image to be scanned by contrasting the brilliance with the real image object, such as scale, pattern, mark, drawing, and lines, etc. are all within the sprites of the present invention. All the design and manufacture of patterns and the way of attachment thereof are also included by the invention, and the kind of document to be scanned, such as a word manuscript, a drawing symbol, or photograph, etc. are also included in a so-called image object to be scanned. The document to be scanned belonged to transparent type or reflective type is all adapted to the present invention.

What is claimed is:

1. A method for automatically distinguishing size of image object, which is a pre-scanning procedure executed on the image object and includes following steps:
a. enter the actuating mode;
b. proceed scanning procedure on the image object, and calculate the variation of brilliance;
c. output the data of image;
d. end the pre-scanning procedure, when the brilliance does not change any more.

2. The method for automatically distinguishing size of image object according to claim 1, wherein said step b is referred as: during the scanning procedure executed on the image object, the variation of brilliance performance in the second scanning direction is calculated under the first scanning direction being fixed, wherein the first scanning direction is the transmission direction of the optical chassis and the second scanning direction is the scanning direction of the optical chassis.

3. The method for automatically distinguishing size of image object according to claim 2, wherein said first scanning direction is the direction of Y-axis of the plane coordination and said second scanning direction is the direction of X-axis of the plane coordination.

4. The method for automatically distinguishing size of image object according to claim 1, wherein said step c is referred as: the image data obtained from the first scanning direction is output under the second scanning direction being fixed.

5. The method for automatically distinguishing size of image object according to claim 1, wherein said step d is referred as: during the scanning procedure executed on the image object, the width of the image object is obtained from the first scanning direction.

6. The method for automatically distinguishing size of image object according to claim 1, wherein the width of the image object may be calculated according to the data generated in the pre-scanning procedure executed in a transmission apparatus in an optical scanning apparatus, when the image object is scanned.

7. A method for automatically distinguishing size of image object, which includes following steps:
a. provide a scanner having a scaled pattern;
b. enter the actuating mode, and perform the pre-scanning procedure;
c. calculate and contrast the brilliance performance of the image object with that of the scaled pattern;
d. determine the size of the image object under the first scanning direction being fixed;
e. output the image data;
f. determine the size of image object under the second scanning direction being fixed;
g. when the brilliance does not change any more, the pre-scanning procedure is ended.

8. The method for automatically distinguishing size of image object according to claim 7, wherein said step c is referred as: during the scanning procedure executed on the image object, the variation of brilliance performance is calculated under the scanning direction being fixed.

9. The method for automatically distinguishing size of image object according to claim 8, wherein the scanning direction of said optical chassis is referred as the X-axis direction of the plane coordination.

10. The method for automatically distinguishing size of image object according to claim 7, wherein said step g is referred as: during the scanning procedure executed on the image object and when the brilliance does not change any more, the pre-scanning procedure executed on the image object to be scanned is ended, and the motion of the optical chassis is stopped by the transmission unit.

11. The method for automatically distinguishing size of image object according to claim 7, wherein said scaled pattern is referred as: a designator of scaled quantification may be generated, after the image object to be scanned is placed on the scanning position.

12. The method for automatically distinguishing size of image object according to claim 7, wherein said scaled pattern is a scaled ruler.

13. The method for automatically distinguishing size of image object according to claim 7, wherein said scaled pattern is a drawing of check.

14. The method for automatically distinguishing size of image object according to claim 7, wherein said scaled pattern may be designed on the surface of a transparent glass for placing an image object to be scanned.

15. The method for automatically distinguishing size of image object according to claim 7, wherein said scaled pattern may be designed on an inner side face of upper cover arranged in the optical scanning apparatus.

16. An apparatus for automatically distinguishing size of image object, which includes:
an optical scanning apparatus;
a scaled pattern, which is designed in the optical apparatus, wherein a relative quantitative relationship may be generated between the scaled pattern and the image object to be scanned;
a scanning means, which is defined as: the optical scanning apparatus may execute a scanning procedure on an image object to be scanned and, through a predetermined value of the scaled pattern, a relationship between the predetermined value and the brilliance of the image object to be scanned is calculated during the scanning procedure and, after the size of the image object to be scanned is known, the scanning procedure is over.

17. The apparatus for automatically distinguishing size of image object according to claim 16, wherein said scaled pattern is a scaled ruler.

18. The apparatus for automatically distinguishing size of image object according to claim 16, wherein said scaled pattern is a drawing of check.

19. The method for automatically distinguishing size of image object according to claim 16, wherein said scaled pattern may be designed at the inner edge of a transparent glass for placing an image object to be scanned.

20. The apparatus for automatically distinguishing size of image object according to claim 16, wherein said scaled pattern may be designed on an inner side face of upper cover arranged in the optical scanning apparatus.
